(19) United States
(12) Patent Application Publication
(10) Pub. No.: US 2013/0155272 A1
(43) Pub. Date: Jun. 20, 2013

(54) IMAGE PROCESSING DEVICE, IMAGING DEVICE, AND IMAGE PROCESSING METHOD

(71) Applicant: Olympus Corporation, Tokyo (JP)

(72) Inventor: Shinichi IMADE, Iruma-shi (JP)

(73) Assignee: OLYMPUS CORPORATION, Tokyo (JP)

(21) Appl. No.: 13/716,717

(22) Filed: Dec. 17, 2012

(30) Foreign Application Priority Data
Dec. 15, 2011 (JP) 2011-274210

(51) Int. Cl. G06T 3/40

(52) U.S. Cl. CPC G06T 3/4007
USPC 348/222.1; 382/300

(57) ABSTRACT

An image processing device includes an image acquisition section, a resampling section, an interpolation section, and an estimation section. The image acquisition section alternately acquires pixel-sum values of a first summation unit group and a second summation unit group in each frame of a plurality of frames. The resampling section calculates a resampling value in the each frame. The interpolation section determines whether or not to interpolate the pixel-sum value that is not acquired in a target frame based on the pixel-sum value acquired in the frame that precedes or follows the target frame based on a time-series change in the resampling value. The estimation section estimates pixel values based on the pixel-sum values.

Japanese Patent Application No. 2011-274210 filed on Dec. 15, 2011, is hereby incorporated by reference in its entirety.

### BACKGROUND

The present invention relates to an image processing device, an imaging device, an image processing method, and the like.

A super-resolution process has been proposed as a method that generates a high-resolution image from a low-resolution image (e.g., High-Vision movie). For example, the maximum-likelihood (ML) technique, the maximum a posteriori (MAP) technique, the projection onto convex sets (POCS) technique, the iterative back projection (IBP) technique, the techniques disclosed in JP-A-2009-124621, JP-A-2008-243037, and JP-A-2011-151569, and the like have been known as a technique that implements the super-resolution process.

### SUMMARY

According to one aspect of the invention, there is provided an image processing device comprising:

an image acquisition section that alternately acquires pixel-sum values of a first summation unit group and a second summation unit group in each frame of a plurality of frames, when each summation unit of summation units for acquiring the pixel-sum values is set on a plurality of pixels, and the summation units are classified into the first summation unit group and the second summation unit group;

a resampling section that performs a resampling process on the acquired pixel-sum values in the each frame to calculate a resampling value of each summation unit of the first summation unit group and the second summation unit group;

an interpolation section that determines whether or not to interpolate the pixel-sum value that is not acquired in a target frame among the plurality of frames based on a time-series change in the resampling value, and interpolates the pixel-sum value that is not acquired in the target frame based on the pixel-sum value acquired in a frame that precedes or follows the target frame; and
an estimation section that estimates pixel values of pixels included in the summation units based on the pixel-sum values acquired in the target frame and the pixel-sum value that has been interpolated by the interpolation section in the target frame.

According to another aspect of the invention, there is provided an imaging device comprising the above image processing device.

According to another aspect of the invention, there is provided an image processing method comprising:
alternately acquiring pixel-sum values of a first summation unit group and a second summation unit group in each frame of a plurality of frames, when each summation unit of summation units for acquiring the pixel-sum values is set on a plurality of pixels, and the summation units are classified into the first summation unit group and the second summation unit group;
performing a resampling process on the acquired pixel-sum values in the each frame to calculate a resampling value of each summation unit of the first summation unit group and the second summation unit group;

determining whether or not to interpolate the pixel-sum value that is not acquired in a target frame among the plurality of frames based on a time-series change in the resampling value, and interpolating the pixel-sum value that is not acquired in the target frame based on the pixel-sum value acquired in a frame that precedes or follows the target frame; and
estimating pixel values of pixels included in the summation units based on the pixel-sum values acquired in the target frame and the pixel-sum value that has been interpolated in the target frame.

### BRIEF DESCRIPTION OF THE DRAWINGS

FIG. 1 is a view illustrating a first interpolation method.

FIG. 2 is a view illustrating a first interpolation method.

FIG. 3 illustrates a configuration example of an imaging device.

FIG. 4 illustrates a configuration example of an image processing device.

FIG. 5 is a view illustrating a second interpolation method.

FIGS. 6A and 6B are views illustrating a second interpolation method.

FIG. 7 illustrates an example of a look-up table used for a third interpolation method.

FIG. 8 is a view illustrating a third interpolation method.

FIG. 9 is a view illustrating a maximum likelihood interpolation method.

FIGS. 10A and 10B are views illustrating a maximum likelihood interpolation method.

FIG. 11A is a view illustrating a pixel-sum value and an estimated pixel value, and FIG. 11B is a view illustrating an intermediate pixel value and an estimated pixel value.

### DESCRIPTION OF EXEMPLARY EMBODIMENTS

Several aspects of the invention may provide an image processing device, an imaging device, an image processing method, and the like that can acquire a high-quality and high-resolution image irrespective of whether an object makes a motion or is stationary.

According to one embodiment of the invention, there is provided an image processing device comprising:

an image acquisition section that alternately acquires pixel-sum values of a first summation unit group and a second summation unit group in each frame of a plurality of frames, when each summation unit of summation units for acquiring the pixel-sum values is set on a plurality of pixels, and the summation units are classified into the first summation unit group and the second summation unit group;

a resampling section that performs a resampling process on the acquired pixel-sum values in the each frame to calculate a resampling value of each summation unit of the first summation unit group and the second summation unit group;

an interpolation section that determines whether or not to interpolate the pixel-sum value that is not acquired in a target frame among the plurality of frames based on a time-series change in the resampling value, and interpolates the pixel-sum value that is not acquired in the target frame based on the pixel-sum value acquired in a frame that precedes or follows the target frame; and

an estimation section that estimates pixel values of pixels included in the summation units based on the pixel-sum values acquired in the target frame and the pixel-sum value that has been interpolated by the interpolation section in the target frame.

According to the image processing device, the resampling value of each summation unit is calculated, and whether or not to interpolate the pixel-sum value is determined based on a time-series change in the resampling value. When it has been determined to interpolate the pixel-sum value, the pixel-sum value that is not acquired in the target frame is interpolated based on the pixel-sum value acquired in the frame that precedes or follows the target frame. The pixel values of the pixels included in the summation units are estimated based on the pixel-sum values. This makes it possible to acquire a high-quality and high-resolution image irrespective of whether an object makes a motion or is stationary.

Exemplary embodiments of the invention are described in detail below. Note that the following exemplary embodiments do not in any way limit the scope of the invention defined by the claims laid out herein. Note also that all of the elements described below in connection with the following exemplary embodiments should not necessarily be taken as essential elements of the invention.

### 1. Outline

A digital camera or a video camera may be designed so that the user can select a still image shooting mode or a movie shooting mode. For example, a digital camera or a video camera may be designed so that the user can shoot a still image having a resolution higher than that of a movie by operating a button when shooting a movie. However, it may be difficult for the user to shoot a still image at the best moment when it is necessary to operate a button.

In order to allow the user to shoot at the best moment, a high-resolution image at an arbitrary timing may be generated from a shot movie by utilizing the super-resolution process. For example, the ML technique, the technique disclosed in JP-A-2009-124621, and the like have been known as a technique that implements the super-resolution process. However, the ML technique, the technique disclosed in JP-A-2009-124621, and the like have a problem in that the processing load increases due to repeated filter calculations, and the technique disclosed in JP-A-2008-243037 has a problem in that an estimation error increases to a large extent when the initial value cannot be successfully specified when estimating the pixel value.

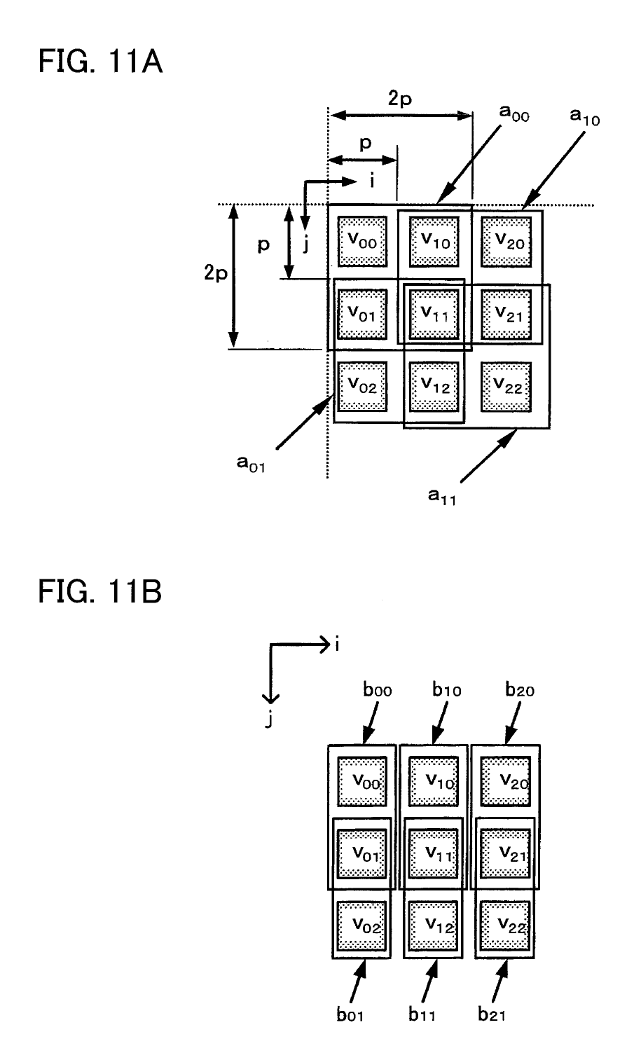

In order to deal with the above problems, several embodiments of the invention employ a method that restores a high-resolution image using a method described later with reference to FIGS. 11A and 11B. According to this method, pixel-sum values aᵢⱼ that share pixels are subjected to a high-resolution process in one of the horizontal direction and the vertical direction to calculate intermediate pixel values bᵢⱼ. The intermediate pixel values bᵢⱼ are subjected to the high-resolution process in the other of the horizontal direction and the vertical direction to calculate pixel values vᵢⱼ. This makes it possible to obtain a high-resolution image by a simple process as compared with a known super-resolution process.

The pixel-sum values aᵢⱼ may be acquired by acquiring the pixel-sum values a₀₀, a₁₀, a₁₁, and a₀₁ in time series (in different frames) while shifting each pixel (see JP-A-2011-151569, for example). However, this method has a problem in that the restoration accuracy decreases when the object makes a motion since four low-resolution frame images are used to restore a high-resolution image.

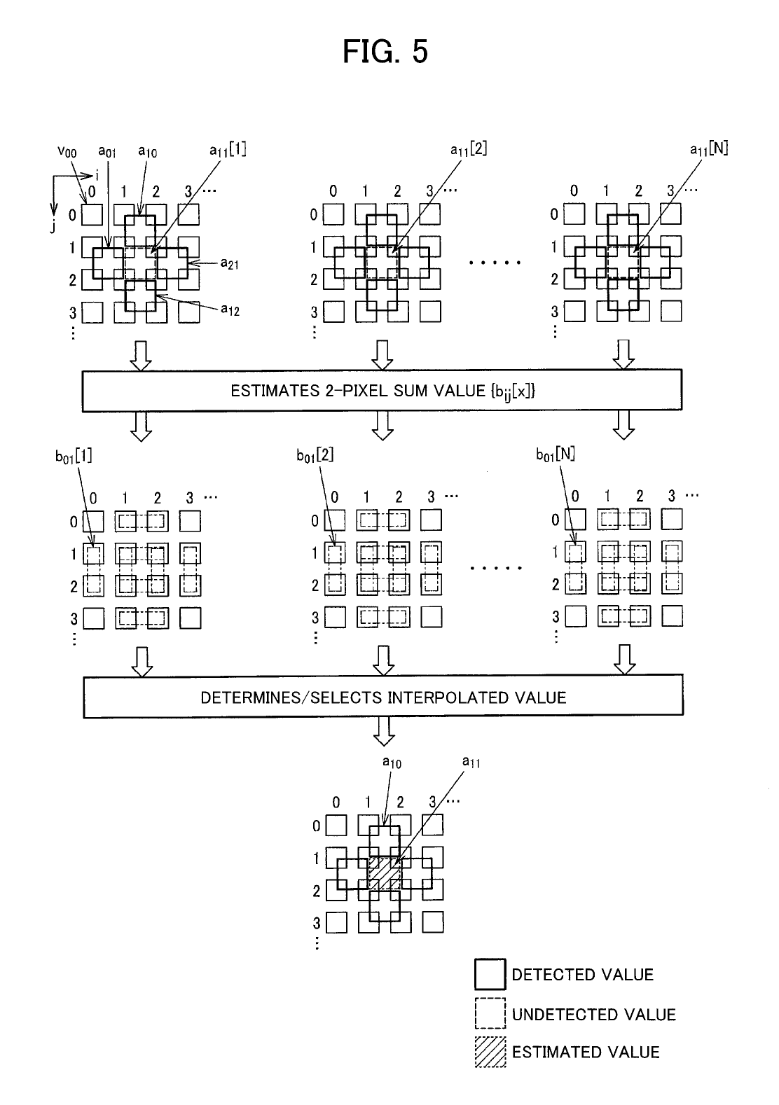

According to several embodiments of the invention, unknown pixel-sum values (e.g., a₁₁) within one frame are interpolated using known pixel-sum values (e.g., a₁₀) within one frame, and a high-resolution image is restored from the known pixel-sum values and the interpolated pixel-sum values (see FIG. 5). According to this method, since a high-resolution image is restored from one low-resolution frame image, the restoration accuracy can be improved (e.g., image deletion can be suppressed) when the object makes a motion. On the other hand, the high-frequency components of the image may be lost due to spatial interpolation.

In order to deal with this problem, a resampling process is performed on the known pixel-sum values (see FIG. 5). When a temporal (time-series) change in the resampling value is small, the unknown pixel-sum value (e.g., aᵢⱼ(T+3)) is substituted with the known pixel-sum value (e.g., aᵢⱼ(T+2)) in the preceding or following frame. It is possible to maintain the high-frequency components of the image by thus interpolating the unknown pixel-sum value using the known pixel-sum value in the preceding or following frame when the object is stationary.

### 2. First Interpolation Method

A first interpolation method that interpolates the pixel-sum value using the pixel-sum value in the preceding or following frame when the object is stationary is described in detail below. Note that the term “frame” used herein refers to a timing at which an image is captured by an image sensor, or a timing at which an image is processed by image processing, for example. Each image included in movie data may be also be appropriately referred to as “frame”.

The following description is given taking an example in which an image sensor includes a Bayer color filter array, and the color Gr among the colors R, Gr, Gb, and B is subjected to the interpolation process. Note that the following description may similarly be applied to the other colors. The following description may also similarly be applied to the case where the pixel values of pixels that differs in color (i.e., R, Gr, Gb, and B) are summed up.

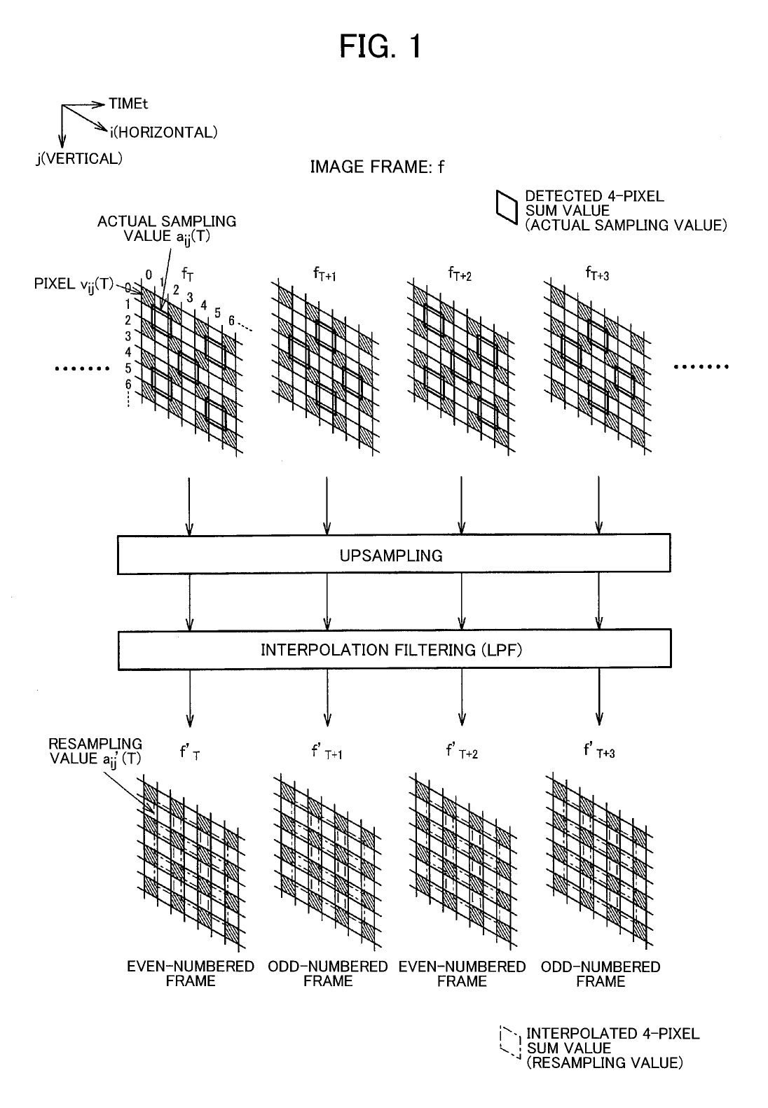

As illustrated in FIG. 1, the pixel-sum values aᵢⱼ are acquired in a staggered pattern in each frame (f_{T}, f_{T+1}, f_{T+2}, fT+3, . . . ). Note that i is an integer equal to or larger than zero, and indicates the position (or the coordinate value) of the pixel vᵢⱼ in the horizontal scan direction, and j is an integer equal to or larger than zero, and indicates the position (or the coordinate value) of the pixel vᵢⱼ in the vertical scan direction. The pixel-sum values aᵢⱼ are obtained by simple summation or weighted summation of four pixel values {vᵢⱼ, v₍ᵢ₊₂₎ᵢ, v₍ᵢ₊₂₎₍₊₂₎, vᵢ₍ⱼ₊₂₎}. The pixel-sum values a₀₀, a₄₀, a₂₂, a₀₄, and a₄₄ are acquired in the even-numbered frames f_{T} and f_{T+2}, and the pixel-sum values a₂₀, a₀₂, a₄₂, a₀₄, and a₂₄ are acquired in the odd-numbered frames f_{T+1} and f_{T+3}, for example.

The expression “staggered pattern” used herein refers to a state in which the pixel-sum values aᵢⱼ have been acquired every other value i or j. A state in which the pixel-sum values aᵢⱼ have been acquired for arbitrary values i and j is referred to as a complete state. For example, i=2a and j=2b (a and b are integers equal to or larger than zero) for the Gr pixels, and a state in which the pixel-sum values aᵢⱼ have been acquired for each combination (a, b) is referred to as a complete state. The pixel-sum values aᵢⱼ where (a, b)=(even number, even number) or (odd number, odd number) are acquired in the even-numbered frame, and the pixel-sum values aᵢⱼ where (a, b)(even number, odd number) or (odd number, even number) are acquired in the odd-numbered frame.

The known pixel-sum values aᵢⱼ acquired in each frame are resampled to obtain a state in which all of the pixel-sum values aᵢⱼ′ have been acquired (i.e., complete resampling values aᵢⱼ′). More specifically, the unknown pixel-sum values aᵢⱼ in each frame are set to “0” (upsampling process), and the resampling values aᵢⱼ′ are calculated by performing an interpolation filtering process. A low-pass filtering process may be used as the interpolation filtering process, for example.

Note that the known pixel-sum value aᵢ may be appropriately referred to as “actual sampling value”, and the pixel-sum value ate may be appropriately referred to as “4-pixel-sum value”. The pixel-sum value in the frame fₜ(t=T, T+1, . . . ) is indicated by aᵢⱼ(t).

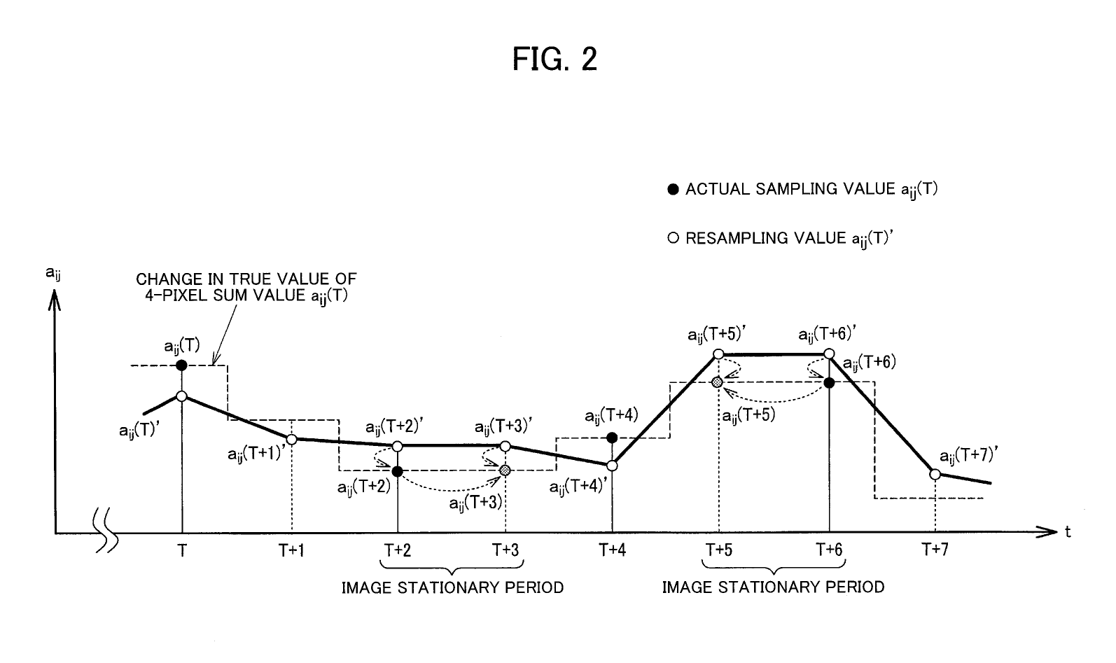

The complete 4-pixel sum values are necessary for restoring a high-resolution image. However, only the actual sampling values in a staggered pattern are acquired by shooting. Therefore, it is necessary to interpolate the unknown 4-pixel sum values that are not acquired by shooting to obtain the complete 4-pixel sum values that include the actual sampling values. A method that interpolates the unknown pixel-sum values aᵢⱼ(t) is described below with reference to FIG. 2.

The pixel values change between frames in a movie that captures the object corresponding to the motion of the object. It is considered that the change in pixel values does not differ to a large extent between the original high-resolution image and a low-resolution image generated using the high-resolution image. Specifically, the motion of the object can be determined by observing a change in the 4-pixel sum values aᵢⱼ(t) between frames.

Since the actual sampling value aᵢⱼ(t) at an identical position (i, j) is obtained every other frame, whether or not a motion occurs between frames at the position (i, j) is determined based on the resampling value aᵢⱼ(t)′. More specifically, it is determined that the motion of the object is absent at the position (i, j) when the resampling value aᵢⱼ(t)′ changes to only a small extent between the adjacent frames. For example, the period T to T+1 between the frames f_{T} and f_{T+1} is determined to be an image stationary period when the following expression (1) is satisfied. Note that d is a given value.

δᵢⱼ(T)=aᵢⱼ(T+1)′−aᵢⱼ(T)′≦d (1)

It is considered that a change in the true value of the 4-pixel sum value aᵢⱼ(t) is small, and it is likely that the true value of the 4-pixel sum value aᵢⱼ(t) is identical in the image stationary period. Therefore, the unknown 4-pixel sum value that is not acquired in the frame ft is substituted with the actual sampling value aᵢⱼ(t) acquired in the frame within the image stationary period. For example, since the actual sampling value aᵢⱼ(T+2) is present in the image stationary period (T+2≦t≦T+3), the unknown pixel-sum value aᵢⱼ(T+3) is substituted with the actual sampling value aᵢⱼ(T+2). Since the actual sampling value aᵢⱼ(T+6) is present in the image stationary period (T+5≦t≦T+6), the unknown pixel-sum value aᵢⱼ(T+5) is substituted with the actual sampling value aᵢⱼ(T+6). This makes it possible to reduce an error between the unknown 4-pixel sum value and the true value in the image stationary period.

It is determined that the motion of the object occurs at the position (i, j) when the resampling value aᵢⱼ(t)′ changes to a large extent between the adjacent frames. For example, the period T to T+1 between the frames f_{T} and f_{T+1} is determined to be an image shake period when the following expression (2) is satisfied.

δᵢⱼ(T)=aᵢⱼ(T+1)′−aᵢⱼ(T)>d (2)

In the image shake period, it is uncertain whether a variation in error occurs due to insufficient intra-frame interpolation or an inter-frame motion. Therefore, the intra-frame interpolated value is used as the unknown 4-pixel sum value. The resampling value aᵢⱼ(t)′ may be used as the intra-frame interpolated value. An interpolated value obtained by an interpolation method described later with reference to FIGS. 5 to 10 may also be used.

The above description has been given using the time axis. A position that corresponds to the image stationary period and a position that corresponds to the image shake period are present in each frame depending on the position (i, j). Specifically, the actual sampling values and the intra-frame interpolated values are present in the image in each frame after substitution. In an identical frame image, the intra-frame interpolated value is applied to the unknown 4-pixel sum value that corresponds to an image with motion, and the actual sampling value is applied to the unknown 4-pixel sum value that corresponds to an image without motion.

The complete 4-pixel sum values aᵢⱼ(t) are thus obtained, and the pixel values vᵢⱼ of a high-resolution image are estimated by applying a restoration process to the complete 4-pixel sum values aᵢⱼ(t). The details of the restoration process are described later with reference to FIGS. 11A and 11B. Further details of the restoration process are described in JP-A-2011-151569.

### 3. Modification of First Interpolation Method

Although an example in which the time-axis (inter-frame) interpolation process is applied to only the 4-pixel sum value that corresponds to an image without motion has been described above, the time-axis (inter-frame) interpolation process may also be applied to the case where a gradual motion occurs (i.e., a linear change occurs). For example, when a change in the resampling value aᵢⱼ(t)′ between the adjacent frames is almost constant, the average value of the actual sampling values may be used as the interpolated value. For example, when the following expression (3) is satisfied in the period T to T+2, the average value of the actual sampling values aᵢⱼ(T) and aᵢⱼ(T+2) may be used as the unknown pixel-sum value aᵢⱼ(T+1). Note that a normal interpolation process may be applied instead of using the average value of the actual sampling values.

aᵢⱼ(T+1)′−aᵢⱼ(T)′≈aᵢⱼ(t+2)′−aᵢⱼ(T+1)′ (3)

Although an example in which the resampling value aᵢⱼ(t)′ is used in the image shake period has been described above, the interpolation process may also be performed using a second interpolation method or a third interpolation method described later with reference to FIGS. 5 to 10. In this case, it is effective to perform the interpolation process using the actual sampling value in the preceding or following frame by applying the first interpolation method, and perform the intra-frame interpolation process on the remaining unknown 4-pixel sum values by applying the second interpolation method to calculate all of the 4-pixel sum values. Specifically, the accuracy of the intra-frame interpolation process is poor when the spatial frequency is high in each direction. If the interpolation process can be accurately performed in the time axis such as in the case of using the first interpolation method, the unknown 4-pixel sum value can be accurately interpolated even if the spatial frequency is high.

### 4. Configuration Example of Imaging Device and Image Processing Device

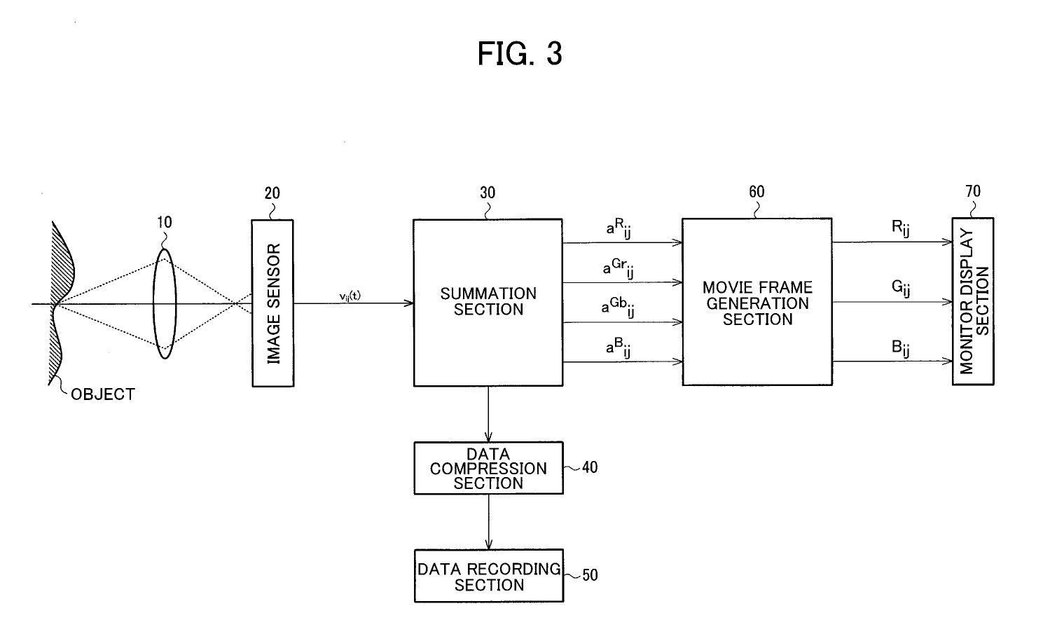

FIG. 3 illustrates a configuration example of an imaging device. The imaging device illustrated in FIG. 3 includes a lens 10, an image sensor 20, a summation section 30, a data compression section 40, a data recording section 50, a movie frame generation section 60, and a monitor display section 70.

The image sensor 20 captures an image of the object formed by the lens 10, and outputs pixel values vᵢⱼ. The image sensor 20 includes a Bayer color filter array, for example. The summation section 30 sums up the pixel values vᵢⱼ on a color basis, and outputs pixel-sum values a^{R}ᵢⱼ, a^{Gr}ᵢⱼ, a^{Gb}ᵢⱼ, and a^{B}ᵢⱼ. The pixel-sum values are acquired in a staggered pattern, for example. The data compression section 40 compresses the pixel-sum values a^{R}ᵢⱼ, a^{Gr}ᵢⱼ, a^{Gb}ᵢⱼ, and a^{B}ᵢⱼ. The data recording section 50 records the compressed data. The data recording section 50 is implemented by an external memory (e.g., memory card), for example.

The movie frame generation section 60 resamples the pixel-sum values a^{R}ᵢⱼ, a^{Gr}ᵢⱼ, a^{Gb}ᵢⱼ, and a^{B}ᵢⱼ to have the number of pixels compliant with the High-Vision standard, for example. The movie frame generation section 60 performs a demosaicing process on the resampled pixel values, and outputs display RGB image data Rᵢⱼ, Gᵢⱼ, and Bᵢⱼ. The movie frame generation section 60 may perform various types of image processing (e.g., high-quality process) on the image obtained by the demosaicing process. The monitor display section 70 is implemented by a liquid crystal device or the like, and displays the RGB image data Rᵢⱼ, Gᵢⱼ, and Bᵢⱼ.

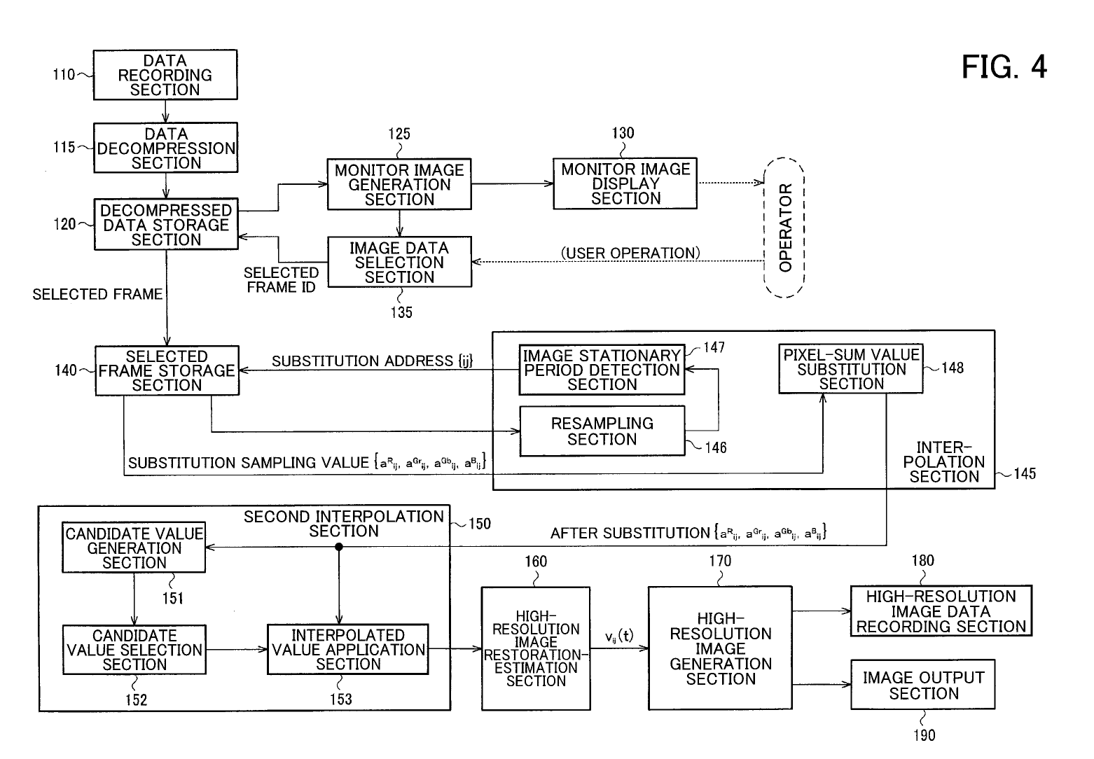

FIG. 4 illustrates a configuration example of an image processing device that restores a high-resolution image from the pixel-sum values acquired (captured) by the imaging device. The image processing device illustrated in FIG. 4 includes a data recording section 110, a data decompression section 115, a decompressed data storage section 120, a monitor image generation section 125, a monitor image display section 130, an image data selection section 135, a selected frame storage section 140, an interpolation section 145, a second interpolation section 150, a high-resolution image restoration-estimation section 160, a high-resolution image generation section 170, a high-resolution image data recording section 180, and an image output section 190.

The image processing device may be an information processing device (e.g., PC) that is provided separately from the imaging device, or an image processing device (e.g., image processing engine) that is provided in the imaging device.

The compressed data recorded by the imaging device is recorded in the data recording section 110. The data recording section 110 is implemented by a reader/writer into which a memory card can be inserted, for example. The data decompression section 115 decompresses the compressed data read from the data recording section 110, and outputs the pixel-sum values a^{R}ᵢⱼ, a^{Gr}ᵢⱼ, a^{Gb}ᵢⱼ, and a^{B}ᵢⱼ to the decompressed data storage section 120. The decompressed data storage section 120 is implemented by a memory (e.g., RAM) provided in the image processing device, for example.

The monitor image generation section 125 generates a display RGB image from the pixel-sum values read from the decompressed data storage section 120, and the monitor image display section 130 displays the RGB image. The user (operator) designates a high-resolution still image acquisition target frame via a user interface (not illustrated in FIG. 4) while watching a movie displayed on the monitor. The image data selection section 135 outputs the ID of the designated frame to the decompressed data storage section 120 as a selected frame ID. The decompressed data storage section 120 outputs the data of the frame corresponding to the selected frame ID and the preceding and following frames to the selected frame storage section 140. The selected frame storage section 140 is implemented by the same memory as the decompressed data storage section 120, for example.

The interpolation section 145 performs the interpolation process using the first interpolation method described above with reference to FIGS. 1 and 2. The interpolation section 145 includes a resampling section 146, an image stationary period detection section 147, and a pixel-sum value substitution section 148.

The resampling section 146 performs the resampling process using the pixel-sum values a^{R}ᵢⱼ, a^{Gr}ᵢⱼ, a^{Gb}ᵢⱼ and a^{B}ᵢⱼ in the selected frame and the preceding and following frames as the actual sampling values to calculate the resampling values. The image stationary period detection section 147 detects an image stationary period based on the resampling values, and outputs information about the position (i, j) of the unknown pixel-sum value in the selected frame that is to be substituted with the actual sampling value. The pixel-sum value substitution section 148 substitutes the pixel-sum value at the position (i, j) with the actual sampling value. The pixel-sum value substitution section 148 outputs the substituted pixel-sum value and the actual sampling values acquired in the selected frame to the second interpolation section 150.

The second interpolation section 150 interpolates the pixel-sum value that has not been interpolated by the interpolation section 145. The details of the interpolation method implemented by the second interpolation section 150 are described later with reference to FIGS. 5 to 10. The second interpolation section 150 includes a candidate value generation section 151, an interpolated value selection section 152, and an interpolated value application section 153.

The candidate value generation section 151 generates a plurality of candidate values for the unknown pixel-sum value. The interpolated value selection section 152 performs the domain determination process on the intermediate pixel value and the high-resolution pixel value estimated from each candidate value, and determines the interpolated value from the candidate values that are consistent with the domain. The interpolated value application section 153 generates the complete pixel sum values necessary for the restoration process using the interpolated value and the known pixel-sum values.

The high-resolution image restoration-estimation section 160 performs the restoration process, and estimates the pixel values vᵢⱼ of the high-resolution image. The details of the restoration process are described later with reference to FIGS. 11A and 11B. The high-resolution image generation section 170 performs a demosaicing process on the Bayer array pixel values vᵢⱼ to generate an RGB high-resolution image. The high-resolution image generation section 170 may perform various types of image processing (e.g., high-quality process) on the RGB high-resolution image. The high-resolution image data recording section 180 records the RGB high-resolution image. The high-resolution image data recording section 180 is implemented by the same reader/writer as the data recording section 110, for example. The image output section 190 is an interface section that outputs the high-resolution image data to the outside. For example, the image output section 190 outputs the high-resolution image data to a device (e.g., printer) that can output a high-resolution image.

Note that the configurations of the imaging device and the image processing device are not limited to the configurations illustrated in FIGS. 3 and 4. Various modifications may be made, such as omitting some of the elements or adding other elements. For example, the data compression section 40 and/or the data decompression section 115 may be omitted. The function of the summation section 30 may be implemented by the image sensor 20, and the image sensor 20 may output the pixel-sum values. The second interpolation section 150 may select the interpolated value using a look-up table. In this case, the candidate value generation section 151 is omitted, and the interpolated value selection section 152 determines the interpolated value referring to a look-up table storage section (not illustrated in the drawings).

According to the first interpolation method, the image processing device includes an image acquisition section, a resampling section, an interpolation section, and an estimation section. As illustrated in FIG. 1, each summation unit of summation units for acquiring the pixel-sum values aᵢⱼ is set on a plurality of pixels (e.g., four pixels). The summation units are classified into a first summation unit group (e.g., {a₀₀, a₄₀, a₂₂, a₄₄}) and a second summation unit group (e.g., {a₂₀, a₀₂, a₄₂, a₂₄}).

The image acquisition section alternately acquires the pixel-sum values of the first summation unit group and the second summation unit group in each frame of the plurality of frames fₜ (t=T, T+1, . . . ). The resampling section performs the resampling process on the acquired pixel-sum values aᵢⱼ(t) (actual sampling values) in the each frame to calculate the resampling value aᵢⱼ(t)′ of each summation unit of the first summation unit group and the second summation unit group. As described above with reference to FIG. 2, the interpolation section determines whether or not to interpolate the pixel-sum value (unknown pixel-sum value aᵢⱼ(T+3)) that is not acquired in the target frame (i.e., interpolation target frame (e.g., f_{T+3}) among the plurality of frames based on a time-series change in the resampling value aᵢⱼ(t)′, and interpolates the pixel-sum value (aᵢⱼ(T+3)) that is not acquired in the target frame based on the pixel-sum value acquired in the frame that precedes or follows the target frame (e.g., the preceding frame f_{T+2}). The estimation section estimates the pixel values vᵢⱼ of the pixels included in the summation units based on the pixel-sum values acquired in the target frame and the pixel-sum value in the target frame that has been interpolated by the interpolation section.

For example, a readout section (not illustrated in the drawings) that reads data from a data recording section 110 (see FIG. 4) corresponds to the image acquisition section included in the image processing device. Specifically, the summation section 30 included in the imaging device (see FIG. 3) sets the first summation unit group and the second summation unit group, and acquires the pixel-sum values of the first summation unit group. The image processing device reads data from the data recording section 110 to acquire the pixel-sum values (actual sampling values) (see FIG. 4). The resampling section corresponds to the resampling section 146 illustrated in FIG. 4, the interpolation section corresponds to the image stationary period detection section 147 and the pixel-sum value substitution section 148 illustrated in FIG. 4, and the estimation section corresponds to the high-resolution image restoration-estimation section 160 illustrated in FIG. 4.

This makes it possible to determine whether or not the motion of the object occurs at the position (i, j) based on a time-series change in the resampling value aᵢⱼ(t)′. The unknown 4-pixel sum value can be interpolated using the value estimated to be close to the true value by interpolating the unknown 4-pixel sum value based on the pixel-sum value acquired in the preceding or following frame when it has been determined that the motion of the object is small. This makes it possible to improve the high-frequency components of the restored image in an area of the image in which the motion of the object is small.

The interpolation section may interpolate the pixel-sum value (aᵢⱼ(T+3)) that is not acquired in the target frame based on the pixel-sum value acquired in the frame that precedes or follows the target frame when the difference between the resampling value (aᵢⱼ(T+3)′) in the target frame (e.g., f_{T+3}) and the resampling value (aᵢⱼ(T+2)′) acquired in the frame that precedes or follows the target frame (e.g., preceding frame f_{T+}2) is equal to or smaller than a given value d.

More specifically, the interpolation section may interpolate the pixel-sum value (aᵢⱼ(T+3)) that is not acquired in the target frame by substituting the pixel-sum value (aᵢⱼ(T+3)) that is not acquired in the target frame with the pixel-sum value (aᵢⱼ(T+2)) acquired in the frame that precedes or follows the target frame.

This makes it possible to determine that the motion of the object is small at the position (i, j) when the difference between the resampling values in the adjacent frames is equal to or smaller than the given value d. It is also possible to use the pixel-sum value that is estimated to be close to the true value as the interpolated value by utilizing the pixel-sum value acquired in the preceding or following frame as the interpolated value.

The interpolation section may interpolate the pixel-sum value (e.g., aᵢⱼ(T+1)) that is not acquired in the target frame based on the pixel-sum values (aᵢⱼ(T), aᵢⱼ(T+2)) acquired in the frames that precede or follow the target frame (see the expression (3)).

According to this configuration, it is possible to employ a more accurate interpolated value by calculating the interpolated value from the pixel-sum values in the preceding and following frames when the pixel-sum value changes linearly (i.e., the object makes a small motion).

### 5. Second Interpolation Method

A second interpolation method that interpolates the unknown pixel-sum value that has not been interpolated by the first interpolation method is described in detail below. The following description is given taking an example in which the unknown pixel-sum value aᵢⱼ has not been interpolated by the first interpolation method. Note that the following description is also applied to the case where another unknown pixel-sum value aᵢⱼ has not been interpolated by the first interpolation method.

As illustrated in FIG. 5, the unknown 4-pixel sum value a₁₁ is interpolated using the known 4-pixel sum values {a₀₁, a₁₀, a₂₁, a₁₂} adjacent to the 4-pixel sum value a₁₁. The 4-pixel sum values {a₀₁, a₂₁, a₁₂} adjacent to the unknown 4-pixel sum value a₁₁ share pixels with the unknown 4-pixel sum value a₁₁, and change when the unknown 4-pixel sum value a₁₁ changes, and vice versa. It is possible to calculate an interpolated value with high likelihood by utilizing the above relationship. The details thereof are described later.

A plurality of candidate values a₁₁[x] (=a₁₁[1] to a₁₁[N]) are generated for the unknown 4-pixel sum value a₁₁. Note that N is a natural number, and x is a natural number equal to or less than N. The candidate value a₁₁[x] is a value within the domain (given range in a broad sense) of the 4-pixel sum value aᵢⱼ. For example, when the domain of the pixel value vᵢⱼ is [0, 1, . . . , M−1] (M is a natural number), the domain of the 4-pixel sum value aᵢⱼ is [0, 1, . . . , 4M−1]. In this case, all of the values within the domain are generated as the candidate values a₁₁[1] to a₁₁[4M] (=0 to 4M−1) (N=4M).

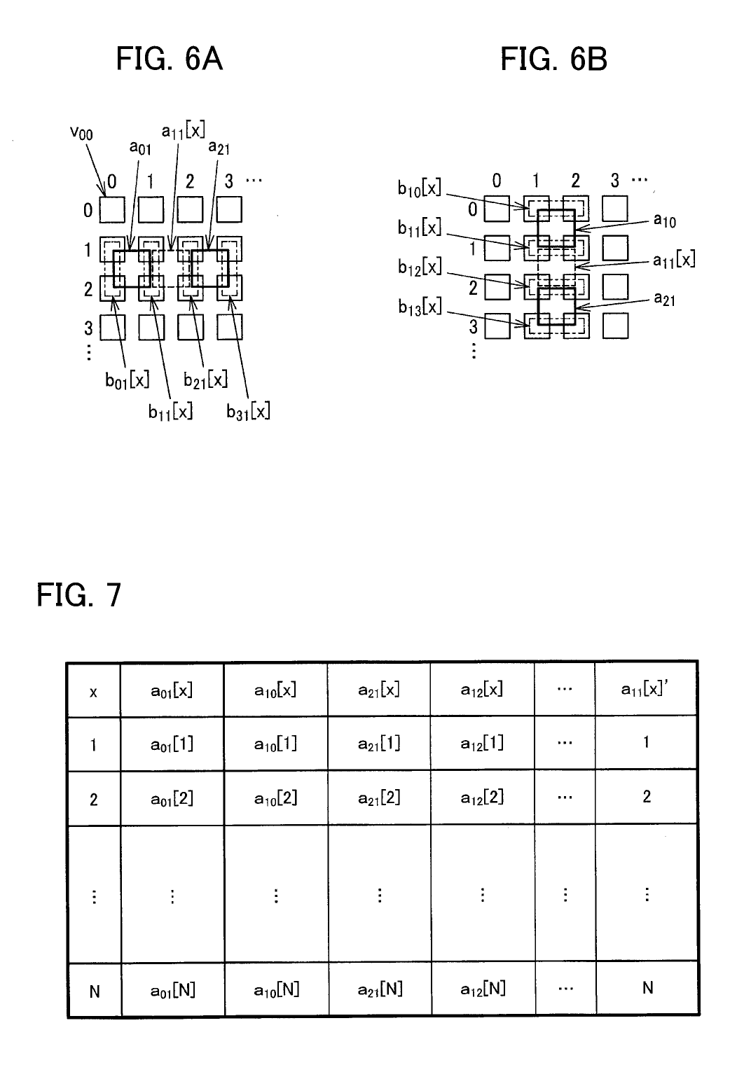

Next, eight 2-pixel sum values are respectively estimated for each candidate value using the candidate value a₁₁[x] and the 4-pixel sum values {a₀₁, a₁₀, a₂₁, a₁₂}. As illustrated in FIG. 6A, the 2-pixel sum values {b₀₁ [x], b₁₁[x]} are estimated from the 4-pixel sum values {a₀₁, a₁₁[x]}, and the 2-pixel sum values {b₂₁[x], b₃₁[x]} are estimated from the 4-pixel sum values {a₁₁[x], a₂₁} in the horizontal direction. Likewise, the 2-pixel sum values {b₁₀[x], b₁₁[x]} are estimated from the 4-pixel sum values {a₁₀, a₁₁[x]}, and the 2-pixel sum values {b₁₂[x], b₁₃[x]} are estimated from the 4-pixel sum values {a₁₁[x], a₁₂} in the vertical direction. The 2-pixel sum values (intermediate pixel values in a broad sense) are estimated as described in detail later with reference to FIGS. 11A and 11B.

Whether or not the eight 2-pixel sum values calculated using the candidate value a₁₁[x] are within the range of the 2-pixel sum values is then determined. For example, when the domain of the pixel value vᵢⱼ is [0, 1, . . . , M−1], the domain of the 2-pixel sum value b₁ is [0, 1, . . . , 2M−1]. In this case, when at least one of the eight 2-pixel sum values calculated using the candidate value a₁₁[x] does not satisfy the following expression (4), the candidate value a₁₁[x] is excluded since the 2-pixel sum values that correspond to the candidate value a₁₁[x] are theoretically incorrect.

0≦bᵢⱼ[x]≦2M−1 (4)

When the number of remaining candidate values is one, the remaining candidate value is determined to be the interpolated value a₁₁. When the number of remaining candidate values is two or more, the interpolated value a₁₁ is determined from the remaining candidate values. For example, a candidate value among the remaining candidate values that is closest to the average value of the adjacent 4-pixel sum values {a₀₁, a₁₀, a₂₁, a₁₂} is determined to be the interpolated value a₁₁.

When the interpolated value a₁₁ has been determined, the complete 4-pixel sum values aᵢⱼ (i.e., the known 4-pixel sum values {a₀₁, a₁₀, a₂₁, a₁₂} and the interpolated value a₁₁) are obtained. The pixel values vᵢⱼ of the original high-resolution image are estimated by applying the restoration process to the complete 4-pixel sum values

According to the second interpolation method, the image processing device may include the second interpolation section 150 (see FIG. 4). The second interpolation section 150 may interpolate the pixel-sum value (unknown pixel-sum value) that is not acquired in the target frame based on the pixel-sum values (known pixel-sum values) acquired in the target frame when the interpolation section 145 has determined not to interpolate the pixel-sum value (unknown pixel-sum value) that is not acquired in the target frame.

This makes it possible to perform the intra-frame interpolation process on an area of the image in which the motion of the object occurs. Since a high-resolution image can be restored based on the pixel-sum values within one frame in an area in which the motion of the object occurs, it is possible to implement a restoration process that can easily deal with the motion of the object as compared with the case of using the pixel-sum values acquired over a plurality of frames.

As illustrated in FIG. 4, the image processing device may include the candidate value generation section 151 and the determination section (candidate value selection section 152). As illustrated in FIG. 5, the image acquisition section may acquire the pixel-sum values (e.g., {a₁₀, a₀₁, a₂₁, a₁₂}) of the first summation unit group in the target frame. The candidate value generation section 151 may generate a plurality of candidate values (e.g., a₁₁[1] to a₁₁[N]) for the pixel-sum values (e.g., a₁₁) of the second summation unit group. The determination section may perform a determination process that determines the pixel-sum values (e.g., a₁₁) of the second summation unit group based on the pixel-sum values (e.g., {a₁₀, a₀₁, a²¹, a₁₂}) of the first summation unit group and the plurality of candidate values (e.g., a₁₁[1] to a₁₁[N]).

It is likely that the amount of data (i.e., the number of pixel-sum values) used for the restoration process decreases, and the accuracy of the restoration process decreases when using only the pixel-sum values within one frame as compared with the case of using the pixel-sum values acquired over a plurality of frames. According to the second interpolation method, however, a plurality of candidate values are generated when interpolating the second summation unit group, and a candidate value with high likelihood that is estimated to be close to the true value can be selected from the plurality of candidate values. This makes it possible to improve the restoration accuracy even if the amount of data is small.

Although the above description has been given taking an example in which the pixel-sum values aᵢⱼ are obtained by summation of a plurality of pixel values, and the plurality of pixel values are restored, each pixel-sum value aᵢⱼ may be the pixel value of one pixel, and the pixel values of a plurality of pixels obtained by dividing the one pixel may be estimated. Specifically, an image may be captured while mechanically shifting each pixel by a shift amount (e.g., p/2) smaller than the pixel pitch (e.g., p) of the image sensor so that one pixel of the image corresponds to each pixel-sum value aᵢⱼ, and the pixel values of a plurality of pixels (e.g., 2²=4 pixels) obtained by dividing the one pixel corresponding to the shift amount may be estimated.

As illustrated in FIG. 5, the first summation unit group may include the summation units having a pixel common to the summation unit (e.g., a₁₁) subjected to the determination process as overlap summation units (e.g., {a₁₀, a₀₁, a₂₁, a₁₂}). The determination section may select a candidate value that satisfies a selection condition (e.g., the expression (4)) based on the domain (e.g., [0 to M−1]) of the pixel values (e.g., vᵢⱼ) from the plurality of candidate values (e.g., a₁₁[1] to a_{11l [N]) based on the pixel-sum values (e.g., {a}₁₀, a₀₁, a₂₁, a₁₂}) of the overlap summation units, and may perform the determination process based on the selected candidate value (e.g., may determine the average value of a plurality of selected candidate values to be the final value).

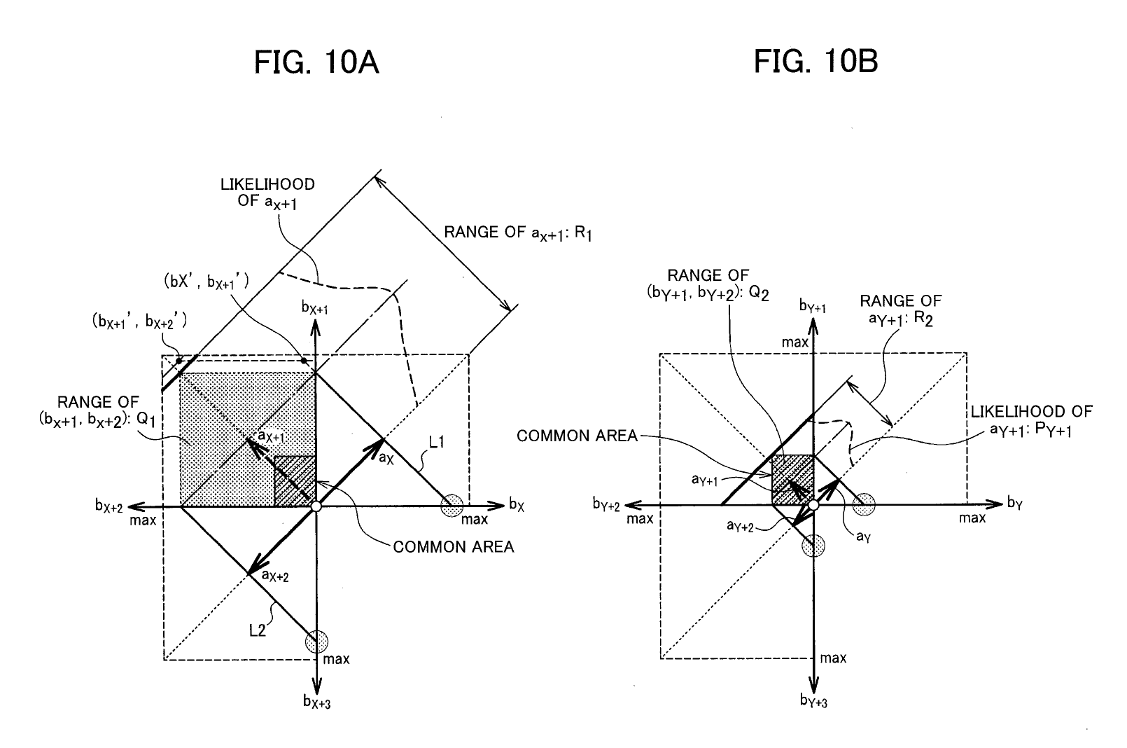

According to the above configuration, since the determination target pixel-sum value a₁₁ and the overlap pixel-sum values {a₁₀, a₀₁, a₂₁, a₁₂} adjacent to the pixel-sum value a₁₁ share a common pixel, the number of candidate values can be reduced by selecting the candidate value that is consistent with the domain. The details thereof are described later with reference to FIGS. 9 and 10.

More specifically, the summation units may include m×m pixels (m is a natural number equal to or larger than 2 (e.g., m=2)) as the plurality of pixels. In this case, the selection condition may be a condition whereby the intermediate pixel values obtained by summation of the pixel values of 1×m pixels or m×1 pixels are consistent with the domain (e.g., [0 to M−1]) of the pixel values (e.g., vᵢⱼ) (see the expression (4)). The determination section may calculate the intermediate pixel values (e.g., bᵢⱼ[x]) corresponding to each candidate value (e.g., a₁₁[x]) based on each candidate value (e.g., a₁₁[x]) and the pixel-sum values (e.g., {a₁₀, a₀₁, a₂₁, a₁₂}) of the overlap summation units, and may select the candidate values (e.g., a₁₁[x]) for which the intermediate pixel values (e.g., bᵢⱼ[x]) satisfy the selection condition.

This makes it possible to select the candidate value that satisfies the selection condition based on the pixel-sum values ({a₁₀, a₀₁, a₂₁, a₁₂}) of the overlap summation units. It is possible to estimate the intermediate pixel values since the adjacent summation units share (have) a common pixel, and select the candidate value using the intermediate pixel value bᵢⱼ (described later with reference to FIGS. 11A and 11B).

The candidate value generation section may generate values within the range (e.g., [0 to 4M−1]) of the pixel-sum values (e.g., aᵢⱼ) based on the domain (e.g., [0 to M−1]) of the pixel values (e.g., vᵢⱼ) as the plurality of candidate values (e.g., a₁₁[1] to an [N=4M] (=0 to 4M−1)).

This makes it possible to select a candidate value with high likelihood that is estimated to be close to the true value from the values within the range of the pixel-sum values aᵢⱼ.

### 6. Third Interpolation Method

A third interpolation method that interpolates the unknown 4-pixel sum value a₁₁ using a look-up table is described below.

When using the third interpolation method, a look-up table is provided in advance using the second interpolation method. More specifically, the second interpolation method is applied to each combination of the 4-pixel sum values {a₀₁, a₁₀, a₂₁, a₁₂} adjacent to the unknown 4-pixel sum value a₁₁ to narrow the range of the candidate value a₁₁ that satisfies the domain of the 2-pixel sum values bᵢⱼ[x]. Each combination of the 4-pixel sum values {a₀₁, a₁₀, a₂₁, a₁₂} and the candidate value a₁₁[x] is thus determined.

As illustrated in FIG. 7, the combination is arranged as a table with respect to the candidate value a₁₁[x]. More specifically, when a₁₁[1]′ to a₁₁[N]′=1 to N, the 4-pixel sum values {a₀₁[x], a₁₀[x], a₂₁[x], a₁₂[x]} correspond to the candidate value a₁₁[x]′. A plurality of combinations {a₀₁[x], a₁₀[x], a₂₁[x], a₁₂[x]} may correspond to an identical candidate value a₁₁[x]′. The above table is effective for implementing a high-speed process.

When calculating the interpolated value a₁₁ from the known 4-pixel sum values {a₀₁, a₁₀, a₂₁, a₁₂}, the look-up table is searched for 4-pixel sum values {a₀₁[x], a₁₀[x], a₂₁ [x], a₁₂[x]} for which the Euclidean distance from each known 4-pixel sum value is zero. The candidate value a₁₁[x]′ that corresponds to the 4-pixel sum values thus searched is determined to be the interpolated value of the unknown 4-pixel sum value a₁₁.

A plurality of candidate values a₁₁[x]′ may be searched corresponding to the known 4-pixel sum value combination pattern {a₀₁, a₁₀, a₂₁, a₁₂}. In this case, the average value of the plurality of candidate values a₁₁[x1]′, a₁₁[x2]′, . . . , and aᵢⱼ[xn]′ (n is a natural number) is determined to be the interpolated value a₁₁ (see the following expression (5)).

a₁₁={a₁₁[x1]′+a₁₁[x2]′+ . . . +a₁₁[xn]′}/n (5)

There may be a case where the number of known 4-pixel sum value combination patterns {a₀₁, a₁₀, a₂₁, a₁₂} is too large. In this case, the number of combination patterns may be reduced (coarse discrete pattern) while coarsely quantizing each component, and the 4-pixel sum values {a₀₁[x], a₁₀[x], a₂₁[x], a₁₂[x]} for which the Euclidean distance from the known 4-pixel sum values {a₀₁, a₁₀, a₂₁, a₁₂} becomes a minimum may be searched.

More specifically, a known value pattern (vector) is referred to as V=(a₀₁, a₁₀, a₂₁, a₁₂), and a pattern of values estimated using the unknown 4-pixel sum value a₁₁[x] as a variable is referred to as V[x]=(a₀₁[x], a₁₀[x], a₂₁[x], a₁₂[x]). An evaluation value E[x] that indicates the difference between V and V[x] is calculated (see the following expression (6)). The estimated value a₁₁[x] at which the evaluation value E[x] becomes a minimum is determined to be (selected as) the interpolated value a₁₁ with high likelihood.

$$E [ x ] = \vert V - V [ x ] \vert = \sqrt{{( {a}_{01} - {a}_{01} [ x ] )}^{2} + {( {a}_{10} - {a}_{10} [ x ] )}^{2} + {( {a}_{21} - {a}_{21} [ x ] )}^{2} + {( {a}_{12} - {a}_{12} [ x ] )}^{2}} \qquad ( 6 )$$

The unknown 4-pixel sum value a₁₁[x] and the known 4-pixel sum values {a₀₁, a₁₀, a₂₁, a₁₂} adjacent to the unknown 4-pixel sum value a₁₁[x] are overlap-shift sum values that share a pixel value (i.e., have high dependence), and the range of the original pixel values vᵢⱼ is limited. Therefore, when the 4-pixel sum value a₁₁[x] has been determined, the pattern V[x]=(a₀₁[x], a₁₀[x], a₂₁[x], a₁₂[x]) that is estimated as the 4-pixel sum values adjacent to the 4-pixel sum value a₁₁[x] is limited within a given range. Accordingly, when the unknown 4-pixel sum value a₁₁[x] has been found so that the estimated pattern V[x] coincides with the known 4-pixel sum value pattern V, or the similarity between the estimated pattern V[x] and the known 4-pixel sum value pattern V becomes a maximum, the unknown 4-pixel sum value a₁₁[x] can be considered (determined) to be the maximum likelihood value of the interpolated value a₁₁.

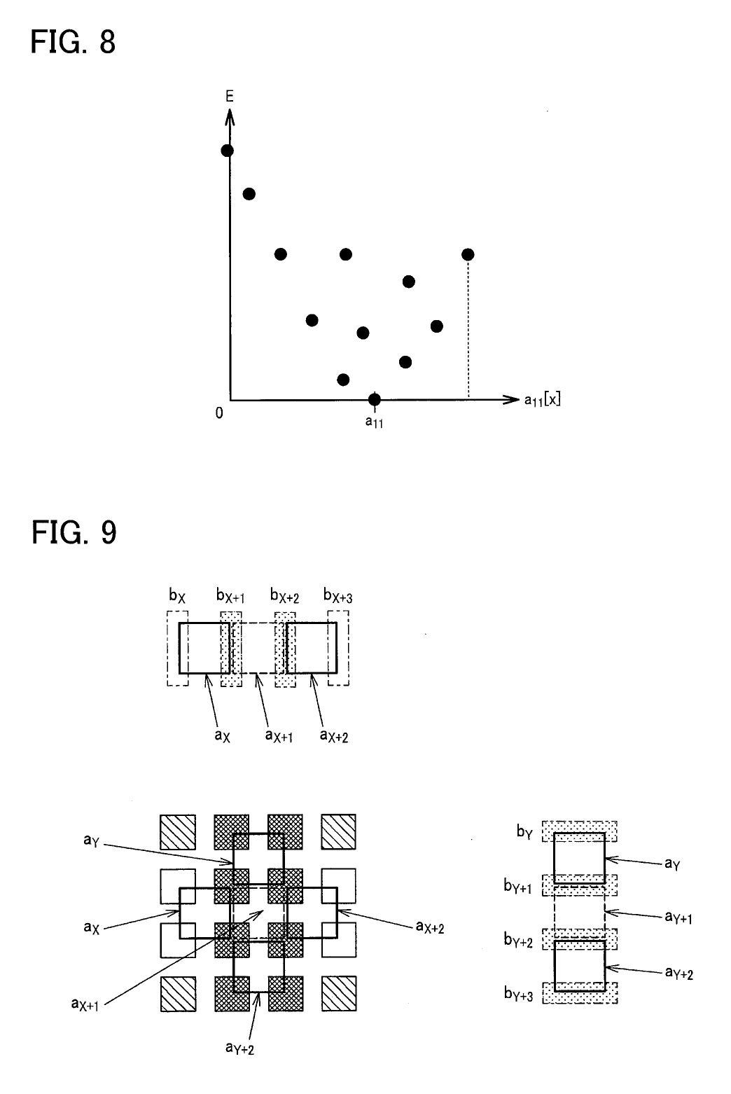

As illustrated in FIG. 8, the 4-pixel sum value a₁₁[x] when the error evaluation value E[x] (see the expression (6)) becomes a minimum with respect to the variable of the unknown 4-pixel sum value a₁₁[x] is specified as the interpolated value a₁₁ with the maximum likelihood. Note that a plurality of unknown 4-pixel sum values a₁₁[x] may be present, and the interpolated value a₁₁ may not be uniquely specified even when the estimated pattern V[x] coincides with the known 4-pixel sum value pattern V. In this case, the interpolated value a₁₁ may be determined by the following method (i) or (ii).

(i) A candidate value among a plurality of candidate values a₁₁[x] obtained from the look-up table that is closest to the average value of the 4-pixel sum values {a₀₁, a₁₀, a₂₁, a₁₂} adjacent to the unknown 4-pixel sum value a₁₁ is selected as the interpolated value a₁₁.
(ii) The average value of a plurality of candidate values a₁₁[x] obtained from the look-up table is selected as the interpolated value a₁₁.

### 7. Maximum Likelihood Interpolation Method

When using the second interpolation method or the third interpolation method, the interpolated value a₁₁ with the maximum likelihood that is estimated to be closest to the true value is determined. The principles thereof are described below.

As illustrated in FIG. 9, the horizontal direction is indicated by a suffix “X”, and the vertical direction is indicated by a suffix “Y”. When the description corresponds to one of the horizontal direction and the vertical direction, the suffix corresponding to the other direction is omitted for convenience. The pixels and the 2-pixel sum values b_{X} and b_{Y} are hatched to schematically indicate the pixel value. A low hatching density indicates that the pixel value is large (i.e., bright).

A 4-pixel sum value a_{X+1}=a_{Y+1} is an interpolated value, and 4-pixel sum values a_{X}, a_{X+2}, a_{Y}, and a_{Y+2} are known 4-pixel sum values. 2-pixel sum values b_{X} to b_{X+3} are estimated from the 4-pixel sum values a_{X} to a_{X+2} in the horizontal direction, and 2-pixel sum values b_{Y} to b_{Y+3} are estimated from the 4-pixel sum values a_{Y} to a_{Y+2} in the vertical direction.

FIG. 10A is a schematic view illustrating the range of the interpolated value a_{X+1}. In FIG. 10A, four axes respectively indicate the 2-pixel sum values b_{X} to b_{X+3}. The known 4-pixel sum value a_{X} is shown by the following expression (7), and is obtained by projecting the vector (b_{X}, b_{X+1}) onto the (1,1) axis. Specifically, the vector (b_{X}, b_{X+1}) when the known 4-pixel sum value a_{X} is given is present on the line L1. Likewise, the vector (b_{X+2}, b_{X+3}) when the known 4-pixel sum value a_{X+2} is given is present on the line L2. Note that the known 4-pixel sum value a_{X} is multiplied by (1/√2) in FIG. 10A for normalization.

a_{X}=b_{X}+b_{X+1}=(1,1)·(b_{X},b_{X+1}) (7)

Since the range Q₁ of the vector (b_{X+1}, b_{X+2}) is thus determined, the range R₁ of the 4-pixel sum value a_{X+1} obtained by projecting the range Q₁ is determined. When using the second interpolation method, all the values within the domain are generated as the candidate values for the 4-pixel sum value a_{X+1}=a₁₁, and the 2-pixel sum values b_{X} to b_{X+3} are estimated for each candidate value. As illustrated in FIG. 10A, when the estimated values (b_{X+1}′, b_{X+2}′) do not satisfy the range Q₁, the value b_{X}′ should be a negative value taking account of projection of (b_{X}′, b_{X+1}′) with respect to the known value a_{X}. Since such a value b_{X}′ does not satisfy the domain, the candidate value corresponding to the estimated values (b_{X+1}′, b_{X+2}′) is excluded. Specifically, only the candidate value that satisfies the range R₁ remains as a candidate.

The range R₁ of the unknown 4-pixel sum value a_{X+1} can thus be narrowed since the unknown 4-pixel sum value a_{X+1} shares pixels with the adjacent 4-pixel sum value a_{X}, and the values a_{X+1} and a_{X} have a dependent relationship through the 2-pixel sum value b_{X+1}.

FIG. 10B is a schematic view illustrating the range of the interpolated value a_{Y+1} in the vertical direction. The range R₂ of the 4-pixel sum value a_{Y+1} is determined in the same manner as the 4-pixel sum value a_{X+1} in the horizontal direction. Since a_{X+1}=a_{Y+1}, the common area of the ranges R₁ and R₂ is the range of the interpolated value a_{X+1}=a_{Y+1}. The known values a_{X} and a_{X+2} are intermediate values in the horizontal direction taking account of the pixel values indicated by hatching (see FIG. 9). In this case, the range R₁ relatively increases (see FIG. 10A), and the range of the interpolated value a_{X+1} cannot be narrowed. As illustrated in FIG. 9, the known values a_{Y} and a_{Y+2} are small in the vertical direction. In this case, the range R₂ relatively decreases (see FIG. 10B), and the range of the interpolated value a_{Y+1} is narrowed. It is possible to narrow the range of the interpolated value (i.e., reduce the number of candidate values) by thus performing the domain determination process in two different directions.

When the probability that the values (b_{Y+1}, b_{Y+2}) coincide with the true value is uniform within the range Q₂ (see FIG. 10B), the probability that the interpolated value a_{Y+1} (projection of the values (b_{Y+1}, b_{Y+2})) is the true value becomes a maximum around the center of the range R₂ (see P_{Y+1}). Therefore, when the number of candidate values remaining after the domain determination process is two or more, it is possible to set the interpolated value a_{Y+1} at which the value P_{Y+1} becomes almost a maximum by setting the average value of the candidate values to be the interpolated value a_{Y+1}.

### 8. Restoration Process

A process that estimates and restores the high-resolution image from the pixel-sum values obtained by the above interpolation process is described in detail below. Note that the process is described below taking the pixel-sum values {a₀₀, a₁₀, a₁₁, a₀₁} as an example, but may also be similarly applied to other pixel-sum values. Note also that the process may also be applied to the case where the number of summation target pixels is other than four (e.g., 9-pixel summation process).

The pixel-sum values aᵢⱼ (4-pixel sum values) illustrated in FIG. 11A correspond to the interpolated value obtained by the interpolation process and the known pixel sum values. As illustrated in FIG. 11B, intermediate pixel values b₀₀ to b₂₁ (2-pixel sum values) are estimated from the pixel-sum values a₀₀ to a₁₁, and the final pixel values v₀₀ to v₂₂ are estimated from the intermediate pixel values b₀₀ to b₂₁.

An intermediate pixel value estimation process is described below taking the intermediate pixel values b₀₀ to b₂₀ in the first row (horizontal direction) as an example. The intermediate pixel values b₀₀ to b₂₀ are estimated based on the pixel-sum values a₀₀ and a₁₀ in the first row (horizontal direction). The pixel values a₀₀ and a₁₀ are shown by the following expression (8).

a₀₀=v₀₀+v₀₁+v₁₀+v₁₁,

a₁₀=v₁₀+v₁₁+v₂₀+v₂₁ (8)

The intermediate pixel values b₀₀, b₁₀, and b₂₀ are defined as shown by the following expression (9).

b₀₀=v₀₀+v₀₁,

b₁₀=v₁₀+v₁₁,

b₂₀=v₂₀+v₂₁ (9)

Transforming the expression (8) using the expression (9) yields the following expression (10).

a₀₀=b₀₀+b₁₀,

a₁₀=b₁₀+b₂₀ (10)

The following expression (11) is obtained by solving the expression (10) for the intermediate pixel values b₁₀ and b₂₀. Specifically, the intermediate pixel values b₁₀ and b₂₀ can be expressed as a function where the intermediate pixel value b₀₀ is an unknown (initial variable).

b₀₀=(unknown),

b₁₀=a₀₀−b₀₀,

b₂₀=b₀₀+δi₀b₀₀+(a₁₀−a₀₀) (11)

The pixel value pattern {a₀₀, a₁₀} is compared with the intermediate pixel value pattern {b₀₀, b₁₀, b₂₀}, and an unknown (b₀₀) at which the similarity becomes a maximum is determined. More specifically, an evaluation function Ej shown by the following expression (12) is calculated, and an unknown (b₀₀) at which the evaluation function Ej becomes a minimum is derived. The intermediate pixel values b₁₀ and b₂₀ are calculated by substituting the value b₀₀ into the expression (11).

$${e}_{ij} = {( \frac{{a}_{ij}}{2} - {b}_{ij} )}^{2} + {( \frac{{a}_{ij}}{2} - {b}_{( i + 1 ) j} )}^{2} , \\ Ej = {\sum }_{i = 0}^{1} {e}_{ij} \qquad ( 12 )$$

The estimated pixel values vᵢⱼ are calculated as described below using the intermediate pixel values bᵢⱼ in the first column (vertical direction). The estimated pixel values vᵢⱼ are calculated in the same manner as the intermediate pixel values bᵢⱼ. Specifically, the following expression (13) is used instead of the expression (10).

b₀₀=v₀₀+v₀₁,

b₀₁=v₀₁+V₀₂ (13)

According to the above restoration process, a first summation unit (e.g., a₀₀) that is set at a first position overlaps a second summation unit (e.g., a₁₀) that is set at a second position that is shifted from the first position (see FIG. 11A). The estimation calculation section (high-resolution image restoration-estimation section 160 illustrated in FIG. 4) calculates the difference δi₀ between the first pixel-sum value a₀₀ (that is obtained by summing up the pixel values of the first summation unit) and the second pixel-sum value a₁₀ (that is obtained by summing up the pixel values of the second summation unit) (see the expression (11)). As illustrated in FIG. 11B, a first intermediate pixel value b₀₀ is the pixel-sum value of a first area (v₀₀, v₀₁) obtained by removing the overlapping area (v₁₀, v₁₁) from the summation unit a₀₀. A second intermediate pixel value b₂₀ is the pixel-sum value of a second area (v₂₀, v₂₁) obtained by removing the overlapping area (v₁₀, v₁₁) from the summation unit a₁₀. The estimation calculation section expresses a relational expression between the first intermediate pixel value b₀₀ and the second intermediate pixel value b₂₀ using the difference δi₀ (see the expression (11)), and estimates the first intermediate pixel value b₀₀ and the second intermediate pixel value b₂₀ using the relational expression. The estimation calculation section calculates the pixel value (v₀₀, v₁₀, v₁₁, v₀₁) of each pixel included in the summation unit using the estimated first intermediate pixel value b₀₀.

The high-resolution image estimation process can be simplified by estimating the intermediate pixel values from the pixel-sum values obtained using the overlap shift process, and calculating the estimated pixel values from the intermediate pixel values. This makes it unnecessary to perform a complex process (e.g., repeated calculations using a two-dimensional filter), for example.

The expression “overlap” used herein means that the summation units have an overlapping area. For example, the expression “overlap” used herein means that the summation unit a₀₀ and the summation unit a₁₀ share two estimated pixels v₁₀ and v₁₁ (see FIG. 11A).

The position of the summation unit refers to the position or the coordinates of the summation unit in the captured image, or the position or the coordinates of the summation unit indicated by estimated pixel value data (image data) used for the estimation process. The expression “position (coordinates) shifted from . . . ” used herein refers to a position (coordinates) that does not coincide with the original position (coordinates).

An intermediate pixel value pattern (b₀₀, b₁₀, b₂₀) may include consecutive intermediate pixel values that include a first intermediate pixel value and a second intermediate pixel value (e.g., b₀₀ and b₂₀). The estimation calculation section may express a relational expression between the intermediate pixel values included in the intermediate pixel value pattern using the first pixel-sum value a₀₀ and the second pixel-sum value a₁₀ (see the expression (11)), and may compare the intermediate pixel value pattern expressed by the relational expression between the intermediate pixel values with the first pixel-sum value and the second pixel-sum value to evaluate the similarity. The estimation calculation section may determine the intermediate pixel values b₀₀, b₁₀, b₂₀ included in the intermediate pixel value pattern based on the similarity evaluation result so that the similarity becomes a maximum.

This makes it possible to estimate the intermediate pixel values based on the pixel-sum values acquired while shifting each pixel so that overlap occurs.

Note that the intermediate pixel value pattern is a data string (data set) of intermediate pixel values within a range used for the estimation process. The pixel-sum value pattern is a data string of pixel-sum values within a range used for the estimation process.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations and the operations of the image processing device, the imaging device, and the like are not limited to those described in connection with the above embodiments. Various modifications and variations may be made.

What is claimed is:

1. An image processing device comprising:
an image acquisition section that alternately acquires pixel-sum values of a first summation unit group and a second summation unit group in each frame of a plurality of frames, when each summation unit of summation units for acquiring the pixel-sum values is set on a plurality of pixels, and the summation units are classified into the first summation unit group and the second summation unit group;
a resampling section that performs a resampling process on the acquired pixel-sum values in the each frame to calculate a resampling value of each summation unit of the first summation unit group and the second summation unit group;
an interpolation section that determines whether or not to interpolate the pixel-sum value that is not acquired in a target frame among the plurality of frames based on a time-series change in the resampling value, and interpolates the pixel-sum value that is not acquired in the target frame based on the pixel-sum value acquired in a frame that precedes or follows the target frame; and
an estimation section that estimates pixel values of pixels included in the summation units based on the pixel-sum values acquired in the target frame and the pixel-sum value that has been interpolated by the interpolation section in the target frame.

2. The image processing device as defined in claim 1,
the interpolation section interpolating the pixel-sum value that is not acquired in the target frame based on the pixel-sum value acquired in the frame that precedes or follows the target frame when a difference between the resampling value in the target frame and the resampling value in the frame that precedes or follows the target frame is equal to or smaller than a given value.

3. The image processing device as defined in claim 1,
the interpolation section interpolating the pixel-sum value that is not acquired in the target frame by substituting the pixel-sum value that is not acquired in the target frame with the pixel-sum value acquired in the frame that precedes or follows the target frame.

4. The image processing device as defined in claim 1,
the interpolation section interpolating the pixel-sum value that is not acquired in the target frame based on the pixel-sum values acquired in the frames that precede or follow the target frame.

5. The image processing device as defined in claim 1, further comprising:
a second interpolation section that interpolates the pixel-sum value that is not acquired in the target frame based on the pixel-sum values acquired in the target frame when the interpolation section has determined not to interpolate the pixel-sum value that is not acquired in the target frame.

6. The image processing device as defined in claim 5,
the image acquisition section acquiring the pixel-sum values of the first summation unit group in the target frame, and
the second interpolation section including:
a candidate value generation section that generates a plurality of candidate values for the pixel-sum values of the second summation unit group; and
a determination section that performs a determination process that determines the pixel-sum values of the second summation unit group based on the pixel-sum values of the first summation unit group and the plurality of candidate values.

7. The image processing device as defined in claim 6,
the first summation unit group including the summation units having a pixel common to the summation unit subjected to the determination process as overlap summation units, and
the determination section selecting a candidate value that satisfies a selection condition from the plurality of candidate values based on the pixel-sum values of the overlap summation units, and performing the determination process based on the selected candidate value, the selection condition being based on a domain of the pixel value.

8. An imaging device comprising the image processing device as defined in claim 1.

9. An image processing method comprising:
alternately acquiring pixel-sum values of a first summation unit group and a second summation unit group in each frame of a plurality of frames, when each summation unit of summation units for acquiring the pixel-sum values is set on a plurality of pixels, and the summation units are classified into the first summation unit group and the second summation unit group;
performing a resampling process on the acquired pixel-sum values in the each frame to calculate a resampling value of each summation unit of the first summation unit group and the second summation unit group;
determining whether or not to interpolate the pixel-sum value that is not acquired in a target frame among the plurality of frames based on a time-series change in the resampling value, and interpolating the pixel-sum value that is not acquired in the target frame based on the pixel-sum value acquired in a frame that precedes or follows the target frame; and
estimating pixel values of pixels included in the summation units based on the pixel-sum values acquired in the target frame and the pixel-sum value that has been interpolated in the target frame.
